(19) United States
(12) Patent Application Publication
(10) Pub. No.: US 2012/0318592 A1
(43) Pub. Date: Dec. 20, 2012

(54) FLAP ACTUATOR FOR MOTOR VEHICLES HAVING AN EMERGENCY FUNCTION

(75) Inventors: Guido Schmid, Triberg (DE); Martin Winker, Wurmlingen (DE)

(73) Assignee: MINEBEA CO., LTD., Nagano-ken (JP)

(21) Appl. No.: 13/495,474

(22) Filed: Jun. 13, 2012

(30) Foreign Application Priority Data
Jun. 15, 2011 (DE) 102011106504.4

(51) Int. Cl. B60K 11/08

(52) U.S. Cl. 180/68.1

(57) ABSTRACT

A motorized actuator (1) for operating flaps in the radiator grille of a motor vehicle for controlling the air intake into the engine compartment. The actuator has an electric motor (2) for operating the flaps. The emergency function ensures that on interruption of the operating voltage (VB), the electric motor (2) is moved to an emergency position. For this purpose, the actuator (1) has an energy storage unit (6). During normal operation, the energy storage unit (6) is charged using a constant-current source (8). In case of failure, the electric motor (2) and its control circuit (5) are supplied from the energy storage unit (6) via a step-up converter (9).

### CROSS-REFERENCE TO RELATED APPLICATIONS

This application claims the benefit of German Patent Application No. 10 2011 106 504.4, filed Jun. 15, 2011, which is incorporated herein by reference as if fully set forth.

### BACKGROUND

The invention relates to a motorized actuator having an emergency function used in particular for operating flaps in the radiator grille of a motor vehicle for controlling the air intake into the engine compartment, having an electric motor, having an operating voltage input, having an energy storage unit and a control circuit, wherein during normal operation, the energy storage unit is charged by the operating voltage and in case of an interruption to the operating voltage, the electric motor is supplied by the energy storage unit, in order to move to an emergency position.

Modern car engines are generally very efficient and thus have low cooling requirements when in partial or low-load operation. Flaps are consequently disposed in the radiator grille that controls the air supply to the engine compartment. The flaps are adjusted using an electric motor that is supplied with an operating voltage via the vehicle electrical system. When the cooling requirement is low, the flaps can be closed thus preventing any air intake into the engine compartment. All the air then flows over the hood or under the vehicle, thus reducing the air resistance of the vehicle. This goes to immediately reduce the fuel consumption of the vehicle. To achieve an overall reduction in fuel consumption, it is thus advantageous to keep the flaps mostly closed.

To prevent the internal combustion engine from overheating should there be an interruption in the voltage supply to the flap actuator, it must be possible for the flaps to be opened automatically in an emergency. This is generally achieved using a spring or some other kind of mechanical emergency opening means.

Here, the spring is disposed such that during normal operation it is tensioned by the electric motor of the flap actuator when closing the flaps. As long as an operating voltage is applied to the electric motor, it is able to provide the counterforce to the spring. Should the operating voltage fail or fall below a specific value, the spring force is greater and the flaps are opened. This also applies in particular when the car engine is stopped. This means that when the vehicle is switched off, the flaps automatically open using the emergency function and the engine compartment is ventilated. This allows the car engine to cool down.

If the car engine is started up again after a long break, it has to first reach its operating temperature (cold start). Until this temperature has been achieved, the engine and especially a catalytic converter do not operate optimally, so that during this period there is increased fuel consumption and thus increased harmful exhaust emissions.

In order to reduce the negative effect of a cold start, one idea is to seal the engine compartment more or less tightly and to allow only a controlled supply of air via the radiator grille flaps. One advantage here is that the engine does not cool down as much when at a standstill and thus achieves its operating temperature more quickly when started up again. Particularly in cold climates this can lead to a marked increase in efficiency since extreme cold starting is eliminated. At the same time, however, it is important that the cooling flaps are not opened as part of the emergency function when switching off the car engine, as has been the case up to now. The emergency opening function should, however, be maintained for other emergency situations. In warmer areas or depending on end user requirements, it could, however, be useful for the cooling flaps to be at least partially opened. At all events, it could also be desirable to adjust the cooling flaps in line with the standing time or with such parameters as the ambient temperature, the engine temperature or the wind force and to readjust them during the standing time where necessary. This kind of emergency function depending on outside circumstances is technically complex and expensive to implement in the known mechanical emergency opening means.

It thus makes sense to realize the emergency opening function also using the electric motor. For this purpose, however, a separate power supply is needed from which the electric motor can be supplied should the regular operating voltage fail, in order to move the flaps to the predetermined emergency position.

From WO 2007/134471 A1, a safety actuator for a flap or a valve in the field of domestic engineering is known. This actuator is designed for a supply voltage of 230VAC, 110VAC, 24VAC/DC or 72VDC. The safety actuator has a capacitive energy storage unit which is charged during normal operation and from which, in case of failure, the energy for the electric motor is taken in order to move to an emergency position. The capacitive energy storage unit basically operates at a low operating voltage, so that the high input voltage to charge the energy storage unit has to be decreased. Conversely, in case of failure, the low voltage of the energy storage unit has to be increased to the operating voltage of the electric motor. This is affected here using a voltage converter that has two modes of operation where it is possible to switch between a step-up and a step-down regulator, the regulators being implemented as switching regulators. The circuit required for this, however, is relatively complex and thus expensive.

### SUMMARY

The object of the invention is thus to provide a flap actuator for use in a motor vehicle that is simpler and more cost-effective than the solution known in the prior art.

Due to the low operating voltage, it is possible to use a simple constant-current source to charge the energy storage unit. Only a step-up converter is then needed in order to convert the low charging voltage of the energy storage unit to the higher operating voltage in case of failure. The constant-current source is much simpler and more cost-effective than the reversible step-down converter in the prior art.

The constant-current source does, however, cause extra energy to be consumed. A preferred embodiment of the invention has means of monitoring the charge status of the energy storage unit and a switch to switch the constant-current source ON or OFF, where the constant-current source is only switched on as long as it takes the energy storage unit to be fully charged. Since the charging time of the energy storage unit is generally very short, the loss of energy due to the constant-current source during charging is negligible.

The energy storage unit preferably has at least one capacitor, particularly having high capacitance. It is thus beneficial if the capacitor is designed as a double-layer capacitor.

### BRIEF DESCRIPTION OF THE DRAWINGS

The invention is described in more detail below with reference to the enclosed drawings.

The drawings show:

FIG. 1 a block diagram of a first embodiment of a flap actuator according to the invention,

FIG. 2 a circuit diagram of a further embodiment of a flap actuator according to the invention, and

FIG. 3 a block diagram of a further embodiment of the invention, having a separate motor controller and storage controller.

### DETAILED DESCRIPTION OF THE PREFERRED EMBODIMENT

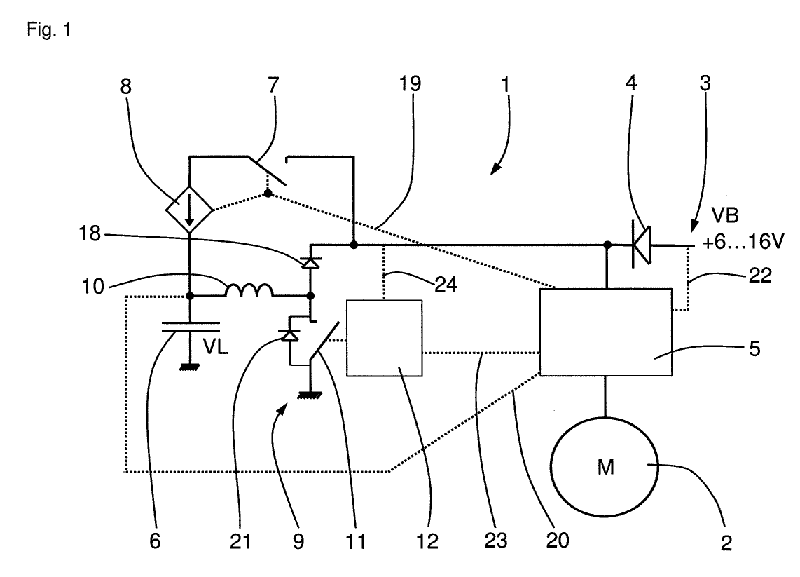

FIG. 1 shows a block diagram of a motorized actuator 1. The actuator 1 is used to operate ventilation flaps in the radiator grille of a motor vehicle (not illustrated) that are moved using an electric motor 2. It is of course clear that the actuator may also be used for other applications such as for controlling valves or other actuators or regulators.

The illustrated flap actuator 1 has an operating voltage input 3 that is connected to the electrical system of the vehicle. The input voltage VB thus lies between 6 VDC and 16 VDC. At the voltage input 3, a protective diode 4 is disposed that acts as reverse polarity protection and prevents current from flowing back into the vehicle electrical system. Alternatively, a P-channel MOSFET may also be used for realizing this reverse polarity protection.

The actuator 1 has an electric motor 2 that is controlled by a control circuit 5. The control circuit 5 may have, for example, a microcontroller and a power switch to switch the operating voltage of the electric motor. These kinds of control circuits 5 are well-known and come in a variety of designs depending on the electric motor 2 used. A more detailed description of its exact function is thus not provided.

During normal operation, an operating voltage VB occurs at the input 3 which is used to operate the motor control 5 and the electric motor 2.

The emergency function of the actuator 1 ensures that the electric motor 2 moves to a predetermined emergency position in case of failure of the operating voltage VB. For this purpose, an emergency power supply is needed that at least allows the required movement to take place.

For this purpose, the flap actuator 1 according to the invention has a capacitive energy storage unit 6. The energy storage unit 6 is preferably designed as a capacitor having high capacitance, particularly as a double-layer capacitor. These double-layer capacitors operate at a low charging voltage VL of some 2.5 V. In normal operation, i.e. when an operating voltage VB is available, the capacitor is charged from this.

Due to the voltage difference between the operating voltage VB and the charging voltage VL of the capacitor 6, it is not possible to directly connect the energy storage unit 6 to the operating voltage VB. The actuator 1 thus has a constant-current source 8 that can be switched on via a switch 7 and that is supplied from the operating voltage VB. The energy storage unit 6 is now connected to this constant-current source 8 and is charged by it.

Moreover, the actuator 1 has a monitor 20 for the charging status of the energy storage unit 6. Since the constant-current source 8 has lower efficiency, it is switched off via the switch 7 as soon as the energy storage unit 6 is full.

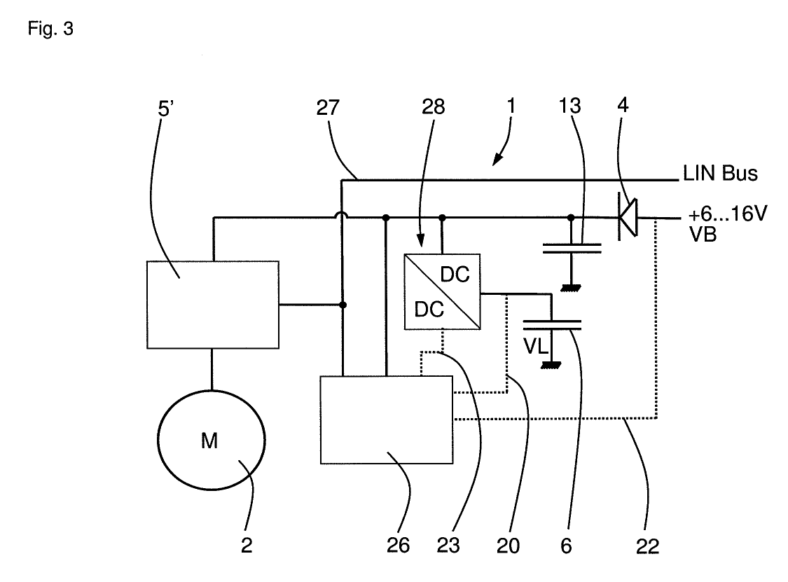

In order to recognize an emergency situation, the actuator 1 has a monitor 22 for the input voltage VB. As soon as the input voltage VB is interrupted or falls below a minimum voltage, the emergency program is activated, should this be required. The electric motor 2 is then supplied from the energy storage unit 6 in order to move to a predetermined emergency position. The actuator, however, is unable to carry out the emergency program if it receives an appropriate signal, preferably via a LIN bus 27 (also see FIG. 3). This situation could occur, for example, when the engine in a motor vehicle is switched off, so that although the voltage supply VB is switched off, no emergency program is to be activated. A park position for the actuator can then be approached. This park position can be approached or changed long after the input voltage VB has been switched off. For example, the temperature or temperature profile at the car engine and/or surroundings can be measured and the position of the flaps of the radiator grille readjusted accordingly.

Since the charging voltage VL of the capacitor 6 is too low to directly drive the electric motor 2, the actuator has a step-up converter 9. This converts the low capacitor voltage VL to the operating voltage VB. The step-up converter 9 is activated in the emergency program by a control command 23.

As a step-up converter, an inductor 10 is connected on one side to the energy storage unit 6 and on the other side to a switch 11 to ground and a diode 18 to the operating voltage VB, wherein the switch 11 can be activated using a converter module 12 and the switch 11 is bridged by a further diode 21.

The converter module 12 has its own monitor for the operating voltage 24 as feedback. Using this feedback, the converter module 12 activates the switch 11 such that the output voltage of the step-up converter 9 is precisely regulated.

The advantage of the electronic emergency function lies in the fact that no complex mechanics susceptible to wear are needed. What is more, the emergency position can also be made dependent on ambient parameters. Using a simple program, it is possible, for example, to ensure that at very low temperatures the air flaps of the radiator grille are not opened, and conversely in warmer surroundings they are opened. Alongside the application for air flaps described in the example, such variable emergency positions are possible for a large number of applications that can be readily realized using the actuator according to the invention.

The monitor for the operating voltage 22, the monitor for the charging status 20, the control 19 for the constant-current source 8 as well as the activation 23 of the step-up regulator 9 are integrated in the example in the motor control 5, since these functions are easy to realize using a microcontroller available there. It is of course clear that one or more of the functions mentioned may also be realized separately.

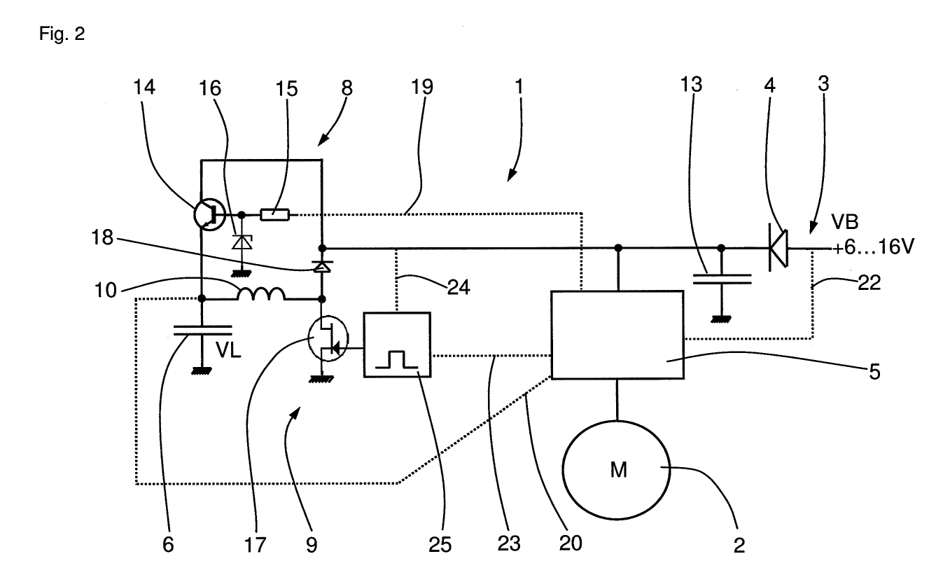

A more precise embodiment of the actuator 1 is shown in FIG. 2. At the operating voltage input 3, a capacitor 13 is additionally disposed as an EMC filter that prevents high-frequency interference from being fed into the vehicle electrical system.

In the example, the constant-current source 8 is realized using a bipolar transistor 14 whose base is controlled via a voltage divider formed of a resistor 15 and a Z-diode 16 by means of a control line 19. An additional switch is thus no longer necessary since the transistor 14 can be switched by the motor control 5 via the control line 19. However, other embodiments for the constant-current source 8 are also possible.

As a step-up converter in this embodiment, an inductor 10 is connected on one side to the energy storage unit 6 and on the other side to a MOSFET switch 17 to ground and a diode 18 to the operating voltage VB, wherein the MOSFET switch 17 can be controlled by a pulse width generator 25. The pulse width generator 25 also has a voltage feedback 24 as a control variable for the MOSFET switch 17.

In normal operation, the energy storage unit 6 is charged using the constant-current source 8. In addition, monitoring of the charging status of the energy storage unit 6 is effected via the line 20. As soon as the energy storage unit 6 is full, the constant-current source 8 is switched off via the control line 19. Since the charging time of the energy storage unit 6 is very short and lasts, for example, for only a few seconds, the overall energy that is lost through the constant-current source 8 is very small.

Moreover, in normal operation the operating voltage VB is monitored. For this purpose, the motor control has a means of monitoring the operating voltage 22. Should the operating voltage VB fail, the EMC capacitor 13 delivers enough energy for a short time for the motor control to activate the step-up converter 9 via a control line 23 and thus to start the supply of power from the energy storage unit 6. As soon as this emergency voltage is applied to the motor control 5, the motor 2 is moved to a predetermined emergency position using this voltage.

Should an operating voltage VB be available again some time later, the motor control 5 again starts charging the energy storage unit 6 during normal operation.

FIG. 3 shows an alternative embodiment of the invention, where two separate controls are provided: a motor control 5′ and a storage control 26. In this embodiment, the motor control 5′ is solely used to control the motor 2. All other functions for monitoring the operating voltage 22, the charging voltage 20 of the energy storage unit 6 and the control 23 of the voltage converter 28 are effected using the storage control 26. The voltage converter 28 shown in the block diagram contains, for example, a constant-current source and a voltage converter according to FIG. 1 or 2.

This separation has the advantage that an electric motor 2 having an integrated motor control 5′, for example, can be used. Then this does not need to contain any functions for storage control.

Nevertheless, a communication connection between the motor control 5′ and the storage control 26 is needed. The motor control 5′ can be alerted by the storage control 26, for example, about a failure in the operating voltage VB, so that an emergency or park position of the motor 2, for example, can be approached. As already mentioned in the description to FIG. 1, the communication connection may also be used to initiate the movement to and change in a park position when no emergency program is activated.

The communication connection is preferably effected using the MN bus 27 that is already available in a motor vehicle. For other applications in particular, the communication connection may also be effected using a direct connection or another bus connection. This direct connection may, for example, transmit a digital signal such as an I/O signal or a PWM signal.

A further advantage of the invention, independent of the specific embodiment, is that crank impulses in the vehicle electrical system can be compensated. These crank impulses are brief voltage drops in the electrical system, where the voltage falls to some 5 V. These kinds of crank impulses occur, for example, in vehicles having a start-stop function for the internal combustion engine while stopping and starting the internal combustion engine, and they generally last for less than a second.

The motorized actuator according to the invention automatically compensates such crank impulses since on a drop in the voltage VB, the electric motor 2 is still briefly supplied from the energy storage unit 6. The crank impulses last only a short time so that the energy stored in the energy storage unit 6 is certainly enough to bridge such a crank impulse. Since the motor 2, and thus the associated motor control as well, is continuously supplied with voltage, no operating parameters are lost, particularly the calibrating data, so that functional capability is maintained at all times. It is thus not necessary after every voltage drop, for instance following a starting or stopping process of the internal combustion engine, to recalibrate the actuator.

### IDENTIFICATION REFERENCE LIST

1 Motorized actuator
2 Electric motor
3 Operating voltage input
4 Protective diode
5,5′ Motor control
6 Energy storage unit
7 Switch
8 Constant-current source
9 Step-up converter
10 Inductor
11 Switch
12 Converter module
13 EMC capacitor
14 Bipolar transistor
15 Resistor
16 Z-diode
17 MOSFET switch
18 Diode
19 Control line constant-current source
20 Monitor for charging status
21 Diode
22 Monitor for operating voltage
23 Control for step-up converter
24 Monitor for step-up converter voltage
25 Pulse width generator
26 Storage control
27 LIN bus
28 Voltage converter
VB Operating voltage
VL Charging voltage

1. A motorized actuator having an emergency function, used for operating flaps in a radiator grille of a motor vehicle for controlling an air supply to the engine compartment, comprising: an electric motor (2), having an operating voltage input (3), an energy storage unit (6), and a control circuit (5), the energy storage unit (6) in normal operation is charged by an operating voltage (VB) and in case of failure of the operating voltage (VB), the electric motor (2) is supplied by the energy storage unit (6) to move to an emergency position, the charging voltage (VL) of the energy storage unit (6) is lower than the operating voltage (VB), the actuator (1) has a constant-current source (8) for charging the energy storage unit (6) using the operating voltage (VB) and a step-up converter (9) for converting the charging voltage (VL) of the energy storage unit (6) to the operating voltage (VB).

2. The motorized actuator according to claim 1, wherein the energy storage unit (6) has at least one capacitor.

3. The motorized actuator according to claim 1, wherein the actuator has a monitor for a charging status (20) of the energy storage unit (6) and a switch (7) to switch the constant-current source (8) ON or OFF, and the constant-current source (8) is only switched on for as long as it takes the energy storage unit (6) to be fully charged.

4. The motorized actuator according to claim 1, wherein as the step-up converter (9), an inductor (10) is connected on one side to the energy storage unit (6) and on the other side to a switch (11) to ground and a diode (18) to the operating voltage (VB), and the switch (11) is controllable using a converter module (12) and the switch (11) is bridged by a further diode (21).

5. The motorized actuator according to claim 1, wherein as a step-up converter (9), an inductor (10) is connected on one side to the energy storage unit (6) and on the other side to a MOSFET switch (17) to ground and a diode (18) to the operating voltage (VB), and the MOSFET switch (17) is controllable by a pulse width generator (25).

6. The motorized actuator according to claim 1, wherein the motor control (5) has a monitor (20, 22) for the operating voltage (VB) and the charging voltage (VL) of the energy storage unit and a control (19, 23) for the constant-current source (8) and the step-up converter (9).

7. The motorized actuator according to claim 1, wherein the actuator (1) has a motor control (5′) that controls the motor and has a storage control (26) and the motor control (5′) and the storage control (26) have a communication connection via which control signals can be exchanged.

8. The motorized actuator according to claim 7, wherein the actuator (1) has a monitor (22) for the operating voltage (VB).

9. The motorized actuator according to claim 7, wherein the actuator (1) has a monitor (20) for the charging voltage (VL) of the energy storage unit (6).

10. The motorized actuator according to claim 7, wherein the actuator (1) has a control (23) for a voltage converter (28) for supplying the energy storage unit (6).

11. The motorized actuator according to claim 1, wherein the communication connection is realized using a LIN bus (27).
